(19) United States
(12) Patent Application Publication
(10) Pub. No.: US 2012/0181721 A1
(43) Pub. Date: Jul. 19, 2012

(54) TIE MANUFACTURING METHOD

(75) Inventor: Kevin Fong Chen, Anaheim, CA (US)

(73) Assignee: Kevin Fong Chen, Anaheim, CA (US)

(21) Appl. No.: 13/314,197

(22) Filed: Dec. 8, 2011

(30) Foreign Application Priority Data
Jan. 18, 2011 (TW) 100101754

(51) Int. Cl. B29D 7/00

(52) U.S. Cl. 264/158

(57) ABSTRACT

A tie manufacturing method includes steps of: mixing materials of polymer material, calcium carbon compound and filling; further mixing the mixture of the materials and an additive with each other as compositions of the tie and feeding the mixture of the compositions of the tie into an extruder for extruding the mixture; forming an elastic structure body from the extruded compositions of the tie; and cutting the elastic structure body to form the tie products. The materials of the ties can be uninterruptedly supplied and formed and directly cut into elastic tie products. Accordingly, the manufacturing cost is lowered and the production rate is increased. Moreover, the tie can be more conveniently and diversely used.

This application claims the priority benefit of Taiwan patent application number 100101754 filed on Jan. 18, 2011.

### BACKGROUND OF THE INVENTION

1. Field of the Invention

The present invention relates generally to a tie, and more particularly to a tie manufacturing method, wherein the materials of the ties can be uninterruptedly supplied and formed and directly cut into elastic tie products. Accordingly, the manufacturing cost is lowered and the production rate is increased. Moreover, the tie can be more conveniently and diversely used.

2. Description of the Related Art

Ties are very popularly and widely used in daily life. For example, a tie can be used to bundle the cables of domestic electrical appliances or electronic products or used to tie up stuffs.

The conventional ties are made from a roll of thin sheet with a preset width and size. One end of the thin sheet must be sequentially placed on five presses in series. The five presses have different molds. The manufacturing method for the ties includes steps of: 1. boring, a first press and a first mold being used to perform this step; 2. toothing, after the thin sheet material advances by the same travel, a second press and a second mold being used to perform this step; 3. cutting edge channel, after the thin sheet material further advances by the same travel, a third press and a third mold being used to perform this step; 4. folding edge, after the thin sheet material further advances by the same travel, a fourth press and a fourth mold being used to perform this step to form folded edges on two sides of the tooth; and 5. cutting off, after the thin sheet material advances by the same travel, a fifth press and a fifth mold being used to perform this step to cut apart the completed ties. In manufacturing, the conventional technique has the following shortcomings:
1. Numerous equipments and molds are used so that the cost is very high.
2. At the beginning of manufacturing process, the thin sheet must be serially connected to different presses in different positions so that the amount of waste material is increased.
3. Numerous presses and molds are used so that a large site is needed for manufacturing the ties. As a result, the rent cost is greatly increased.
4. Numerous presses are used and the numerous presses respectively have different strokes and speeds so that it is hard to control and operate these presses. As a result, the ratio of defective products is higher and the molds are subject to damage. This will lower the yield.
5. After the ties are formed, it is necessary to further trim the ties to remove the redundant material.

The conventional tie is made of plastic material by molding and formed with a latch seat and a strip body. The strip body can be latched and located in the latch seat. After located, the strip body cannot be detached from the latch seat. This leads to waste of resource and causes environmental protection problem. As a result, the cost will be inevitably increased. Moreover, it is inconvenient to use the conventional tie.

Some manufacturers have developed another type of tie structure, which can tied up and loosened. However, when it is desired to loosen the tie, a user needs to continuously press the narrow press end of the strip body with a fingernail or a tip of a tool for totally extracting the strip body. After a long period of press, the user's finger will feel uncomfortable or even painful. Therefore, it is inconvenient to use such tie structure. Furthermore, due to the small press area of the press end, it is hard for a user to truly press the press end. Therefore, the tie cannot be easily and safely untied. In addition, with the additional press end, the tie is manufactured at higher cost.

Moreover, the conventional tie itself has no elasticity. Therefore, when using the conventional tie to tie up soft articles (such as hairs, package bags, receptacle bags and irregular soft bodies), it often takes place that the soft articles are simply loosely tied with the tie. In this case, the soft articles can be hardly securely tied up and is apt to loosen from the tie. Therefore, the conventional tie is unsuitable for soft articles and is only suitable to be used to tie up hard articles (such as cables and stuffs).

### SUMMARY OF THE INVENTION

A primary object of the present invention is to provide a tie manufacturing method, wherein the materials of the ties can be uninterruptedly supplied and formed and directly cut into tie products.

A further object of the present invention is to provide the above tie manufacturing method for manufacturing elastic ties.

A still further object of the present invention is to provide the above tie manufacturing method by which the ties are manufactured at lower cost and at higher production rate.

A still further object of the present invention is to provide the above tie manufacturing method, wherein the tie can be more conveniently and diversely used.

To achieve the above and other objects, tie manufacturing method of the present invention includes steps of: mixing materials of polymer material, calcium carbon compound and filling; further mixing the mixture of the materials and an additive with each other as compositions of the tie and feeding the mixture of the compositions of the tie into an extruder for extruding the mixture; forming an elastic structure body from the extruded compositions of the tie; and cutting the elastic structure body to form the tie products. The materials of the ties can be uninterruptedly supplied and formed and directly cut into elastic tie products. Accordingly, the manufacturing cost is lowered and the production rate is increased. Moreover, the tie can be more conveniently and diversely used.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart of a first embodiment of the tie manufacturing method of the present invention;

FIG. 2 is a block diagram of the first embodiment of the tie manufacturing method of the present invention;

FIG. 3 is a perspective view of the elastic structure body of the present invention;

FIG. 4 is a perspective view of the tie of the present invention; and

FIG. 5 is a flow chart of a second embodiment of the tie manufacturing method of the present invention.

### DETAILED DESCRIPTION OF THE PREFERRED EMBODIMENTS

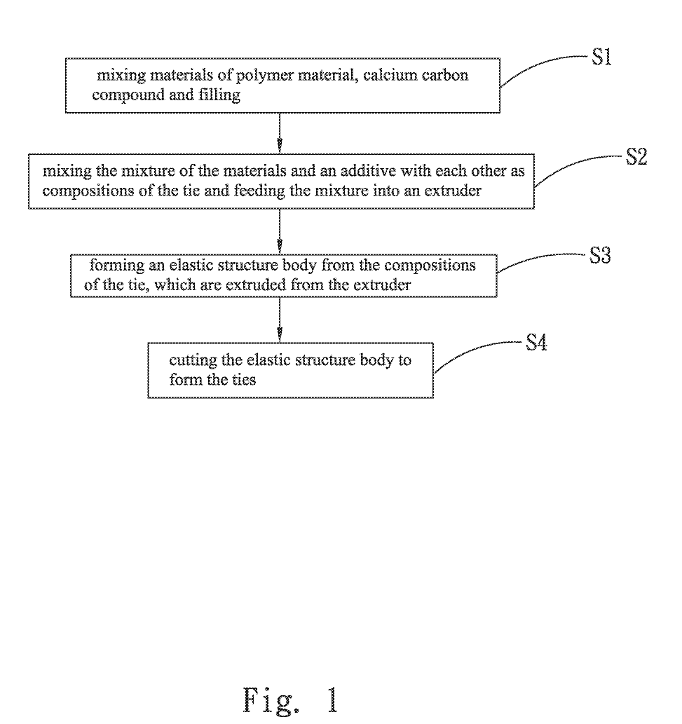

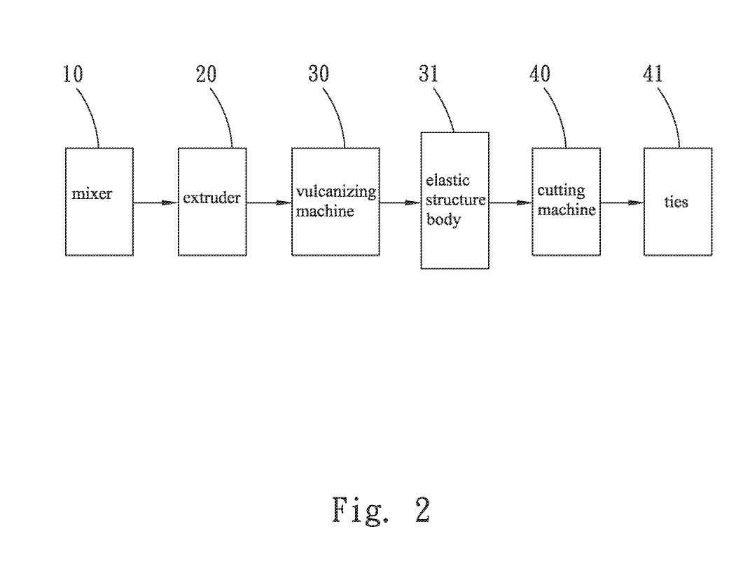

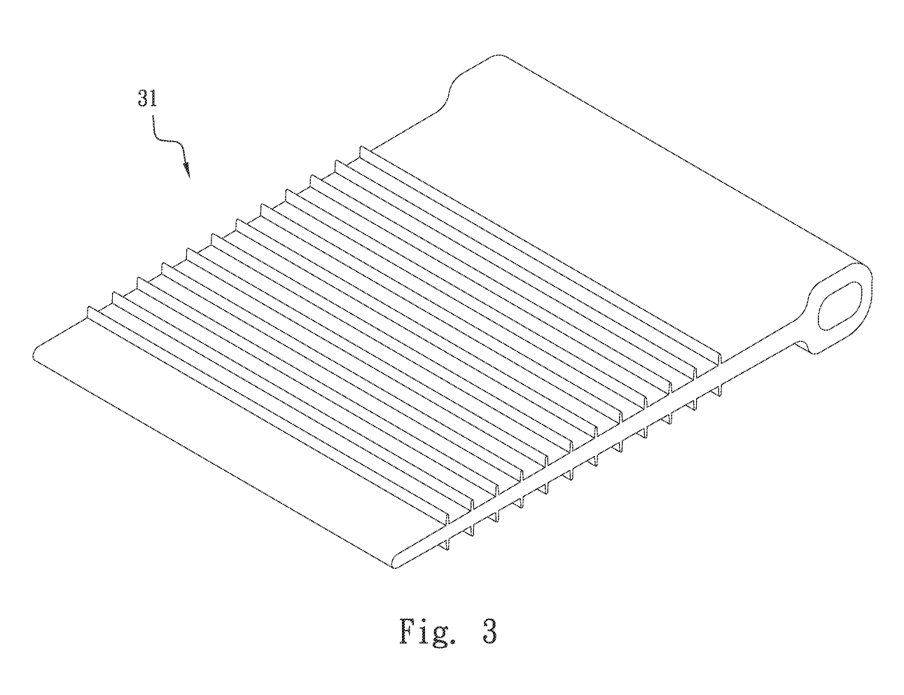

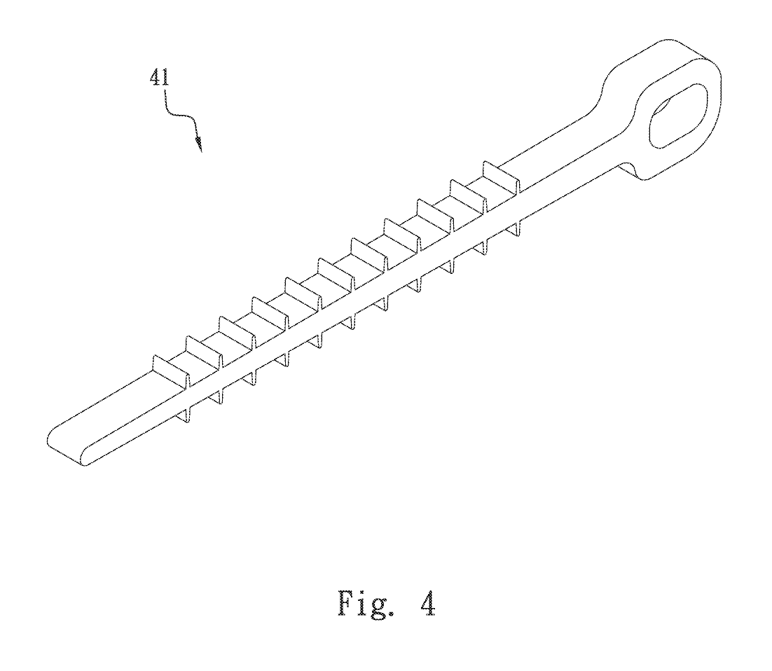

Please refer to FIGS. 1, 2, 3 and 4. FIG. 1 is a flow chart of a first embodiment of the tie manufacturing method of the present invention. FIG. 2 is a block diagram of the first embodiment of the tie manufacturing method of the present invention. FIG. 3 is a perspective view of the elastic structure body of the present invention. FIG. 4 is a perspective view of the tie of the present invention. According to the first embodiment, the tie manufacturing method of the present invention includes steps of:

S1: mixing materials of polymer material, calcium carbon compound and filling, the polymer material, calcium carbon compound and filling being prepared and mixed with each other by means of a mixer 10, the polymer material being selected from a group consisting of rubber material, plastic material and a mixture of rubber material and plastic material, the rubber material being selected from a group consisting of natural rubber, synthetic rubber, and a mixture of natural rubber and synthetic rubber, the plastic material being selected from a group consisting of LDPE, PE, HDPE, PVC and a mixture thereof, the polymer material, calcium carbon compound and filling being placed into the mixer 10 and mixed therein;

S2: mixing the mixture of the materials and an additive with each other as compositions of the tie and feeding the mixture into an extruder, after the materials of polymer material, calcium carbon compound and filling are uniformly mixed by the mixer 10, an additive being added into the mixture of the materials, the additive including: distemper, the distemper being prescribed and added mainly according to the required color of the formed tie; foaming formula gel, the foaming formula gel being prescribed and added mainly according to the control of foaming condition of the polymer material; sulfuration formula gel, the sulfuration formula gel being prescribed and added mainly according to the sulfuration condition of the polymer material; and functional material including antiager material, antioxidant material, high temperature resistant material and refractory material, the functional material being prescribed and added mainly according to the use requirement of the tie product, after the mixture of the materials and the additive are mixed with each other as compositions of the tie, the mixture being fed into the extruder 20, the extruder 20 having a mold designed with a configuration adapted to the configuration of the tie product, the compositions of the tie being continuously molded and extruded by means of the mold;

S3: forming an elastic structure body from the compositions of the tie, which are extruded from the extruder, in the case that the polymer material includes plastic material and rubber material, when the compositions of the tie pass through a vulcanizing machine 30, the vulcanizing machine 30 heating and foaming the compositions of the tie and adding sulfur material into the compositions of the tie to vulcanize the compositions of the tie to form the elastic structure body 31, wherein the foaming and vulcanization processes are respectively performed, alternatively, in the case that the polymer material simply includes plastic material, when the compositions of the tie pass through the vulcanizing machine 30, the vulcanizing machine 30 heating and foaming the compositions of the tie to form the elastic structure body 31, wherein the foaming process is performed without adding sulfur material into the compositions of the tie for vulcanization effect, still alternatively, in the case that the polymer material simply includes rubber material, when the compositions of the tie pass through the vulcanizing machine 30, the vulcanizing machine 30 adding sulfur material into the compositions of the tie to vulcanize the compositions of the tie to form the elastic structure body 31, wherein the vulcanization process is performed without the foaming process to achieve the necessary elasticity, whereby the foaming process can be performed or omitted according to requirements, FIG. 3 showing the elastic structure body 31 discharged from the vulcanizing machine 30, which has a configuration of continuously extending tie products, whereby the tie products will have elasticity, malleability and ductility; and

S4: cutting the elastic structure body to form the ties, the elastic structure body 31 with the configuration of continuously extending tie products being sent to a cutting machine 40 for cutting the elastic structure body 31 into the ties 41 according to the necessary specification as shown in FIG. 4. According to the above arrangement, the material can be uninterruptedly supplied and formed and directly cut into elastic tie products. This can lower manufacturing cost and increase production rate. Moreover, thank to the elasticity of the elastic structure body 31, the tie can be more conveniently and diversely used.

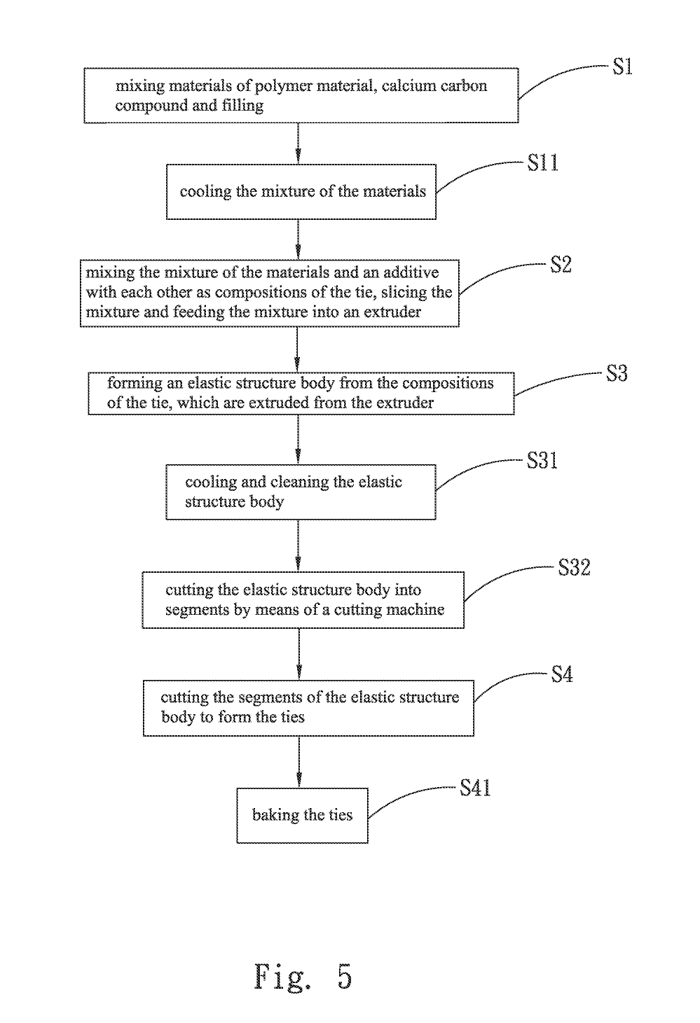

FIG. 5 is a flow chart of a second embodiment of the tie manufacturing method of the present invention. According to the second embodiment, the tie manufacturing method of the present invention includes steps of:

S1: mixing materials of polymer material, calcium carbon compound and filling;

S11: cooling the mixture of the materials;

S2: mixing the mixture of the materials and an additive with each other as compositions of the tie, slicing the mixture and feeding the mixture into an extruder;

S3: forming an elastic structure body from the compositions of the tie, which are extruded from the extruder;

S31: cooling and cleaning the elastic structure body;

S32: cutting the elastic structure body into segments by means of a cutting machine;

S4: cutting the segments of the elastic structure body to form the ties; and

S41: baking the ties.

The materials of polymer material, calcium carbon compound and filling are mixed with each other by means of a mixer 10. After mixed, the mixture of the materials is cooled. After the mixture of the materials and the additive are mixed with each other as compositions of the tie, the mixture is sliced and fed into the extruder 20. The compositions of the tie, which are extruded and molded by the extruder, are then sent to a vulcanizing machine 30 for foaming and vulcanizing the compositions of the tie to form the elastic structure body 31. The elastic structure body 31 is then cooled and cleaned. Then the elastic structure body 31 is cut into segments by means of a cutting machine 40. Then the segments of the elastic structure body 31 are cut into the ties 41 with a necessary specification by means of the cutting machine 40. Then the ties 41 are baked at low temperature to fully volatilize the residual additive. Accordingly, the manufacturing cost of the ties 41 is lowered and the production rate is increased.

In conclusion, the tie manufacturing method of the present invention has the following advantages:

1. The manufacturing cost is lowered.

2. The production rate is increased.

3. The tie has elasticity.

4. The tie can be more conveniently used.

5. The tie can be more diversely used.

The above embodiments are only used to illustrate the present invention, not intended to limit the scope thereof. It is understood that many changes and modifications of the above embodiments can be made without departing from the spirit of the present invention. The scope of the present invention is limited only by the appended claims .

What is claimed is:

1. A tie manufacturing method comprising steps of:
mixing materials of polymer material, calcium carbon compound and filling;
mixing the mixture of the materials and an additive with each other as compositions of the tie and feeding the mixture into an extruder;
forming an elastic structure body from the compositions of the tie, which are extruded from the extruder; and
cutting the elastic structure body to form the ties.

2. The tie manufacturing method as claimed in claim 1, wherein the polymer material is selected from a group consisting of rubber material, plastic material and a mixture of rubber material and plastic material.

3. The tie manufacturing method as claimed in claim 2, wherein the plastic material is selected from a group consisting of materials of LDPE, PE, HDPE, PVC and a mixture of at least two of the above materials.

4. The tie manufacturing method as claimed in claim 2, wherein the rubber material is selected from a group consisting of natural rubber, synthetic rubber, and a mixture of natural rubber and synthetic rubber.

5. The tie manufacturing method as claimed in claim 1, wherein the materials are mixed by means of a mixer and after mixed, the mixture is cooled.

6. The tie manufacturing method as claimed in claim 1, wherein the additive is selected from a group consisting of materials of distemper, foaming formula gel, sulfuration formula gel, antioxidant material, antiager material, high temperature resistant material, refractory material and a mixture of at least two of the above materials.

7. The tie manufacturing method as claimed in claim 1, wherein after the mixture of the materials and the additive are mixed with each other as compositions of the tie, the mixture of the compositions of the tie is sliced and fed into the extruder.

8. The tie manufacturing method as claimed in claim 1, wherein after extruded from the extruder, the compositions of the tie are sent to a vulcanizing machine for vulcanizing the compositions of the tie to form the elastic structure body.

9. The tie manufacturing method as claimed in claim 1, wherein after extruded from the extruder, the compositions of the tie are sent to a vulcanizing machine for heating and foaming the compositions of the tie to form the elastic structure body.

10. The tie manufacturing method as claimed in claim 1, wherein after extruded from the extruder, the compositions of the tie are sent to a vulcanizing machine for heating, foaming and vulcanizing the compositions of the tie to form the elastic structure body.

11. The tie manufacturing method as claimed in claim 1, wherein the elastic structure body is cooled and cleaned and cut into segments by means of a cutting machine.

12. The tie manufacturing method as claimed in claim 1, wherein the elastic structure body is baked to volatilize the additive.
